(19) United States
(12) Patent Application Publication
(10) Pub. No.: US 2022/0212145 A1
(43) Pub. Date: Jul. 7, 2022

(54) APPARATUS FOR REMOVING FINE PARTICLE AND METHOD FOR REMOVING FINE PARTICLE

(71) Applicant: KURITA WATER INDUSTRIES LTD., Tokyo (JP)

(72) Inventors: Yoichi TANAKA, Tokyo (JP); Yu FUJIMURA, Tokyo (JP); Hideaki IINO, Tokyo (JP); Takahiro KAWAKATSU, Tokyo (JP)

(21) Appl. No.: 17/441,041

(22) PCT Filed: Mar. 12, 2020
(86) PCT No.: PCT/JP2020/010819

§ 371 Date: Sep. 20, 2021

(30) Foreign Application Priority Data
Mar. 29, 2019 (JP) 2019-066872

(51) Int. Cl. B01D 61/18; B01D 61/14; B01D 69/02

(52) U.S. Cl. CPC B01D 61/18; B01D 61/145; B01D 2325/16; B01D 69/02; B01D 2325/14; B01D 61/147

(57) ABSTRACT

There is provided an apparatus for removing fine particles having membranes for removing fine particles in a liquid, wherein a microfiltration membrane or ultrafiltration membrane having a positive charge and a microfiltration membrane or ultrafiltration membrane having a negative charge are arranged in series. There is also provided a method for removing fine particles using the apparatus. Liquids may be passed through the membrane having a negative charge and the membrane having a positive charge in order; thereby, extrafine particles having a particle size of 50 nm or smaller, especially of 10 nm or smaller, in the liquids can be removed highly. The liquid passing may be carried out in the order reverse thereto.

### TECHNICAL FIELD

The present invention relates to an apparatus for removing fine particles and a method for removing fine particles, which remove fine particles in liquids in pure water and ultrapure water production processes, electronic parts production or semiconductor cleaning processes and the like. The present invention is useful, particularly in sub-systems and feed-water lines before use points in ultrapure water production and feed systems, and systems of electronic parts production processes, semiconductor cleaning processes and the like, as a technology of highly removing extrafine particles having a particle size of 50 nm or smaller, especially of 10 nm or smaller in liquids.

### BACKGROUND ART

There is conventionally proposed, as a filtration filter for semiconductor and electronic parts production and the like and a filtration filter used in the steps in semiconductor and electronic parts production processes, a positively charged membrane, specifically, a polyketone porous membrane having one or more functional groups selected from the group consisting of a primary amino group, a secondary amino group, a tertiary amino group and a quaternary ammonium salt on a polyketone membrane (Patent Literature 1).

There is also proposed, as a negatively charged membrane used as a filtration filter for fractionating anionic particles, a membrane having one or more functional groups selected from the group consisting of a sulfonic acid group, sulfonate ester groups, a carboxylic acid group, carboxylate ester groups, a phosphoric acid group, phosphate ester groups and a hydroxyl group on a polyketone membrane (Patent Literature 2).

### CITATION LIST

### Patent Literature

PTL 1; JP 2014-173013 A

PTL: JP 2014-171979 A

### SUMMARY OF INVENTION

### Technical Problem

The membrane for removing fine particles using a cationic membrane has such a problem that the removing performance on positively charged fine particles is degraded; and the membrane using an anionic membrane has such a problem that the removing performance on negatively charged fine particles is degraded. Further from the cationic membrane, TOC components elute.

The present invention has an object to provide an apparatus for removing fine particles and a method for removing fine particles, which are excellent in the fine particle removing performance.

### Solution to Problem

As a result of exhaustive studies in order to solve the above problems, the present inventors have found that by disposing a cation membrane and an anion membrane in series, both positively charged particles and negatively charged fine particles can collectively be removed; and this finding has led to the completion of the present invention.

That is, the present invention has the following gist.

[1] An apparatus for removing fine particles, comprising membranes for removing fine particles in a liquid, wherein a microfiltration membrane or ultrafiltration membrane having a positive charge, and a microfiltration membrane or ultrafiltration membrane having a negative charge are arranged in series.

[2] A method for removing fine particles, using the apparatus for removing fine particles according to [1].

[3] The method for removing fine particles according to [2], wherein a liquid is passed through the membrane having a negative charge and the membrane having a positive charge in order.

[4] The method for removing fine particles according to [2], wherein a liquid is passed through the membrane having a positive charge and the membrane having a negative charge in order.

### Advantageous Effects of Invention

According to the present invention, extrafine particles having a particle size of 50 nm or smaller, especially of 10 nm or smaller in a liquid can highly be removed.

According to the present invention, from water systems in general, particularly various types of liquids in pure water or ultrapure water production processes, electronic parts productions and semiconductor cleaning processes, extrafine particles can be highly removed to enhance purification efficiently.

### BRIEF DESCRIPTION OF DRAWINGS

FIG. 1 is a schematic diagram to interpret the fine particle capturing mechanism by cationic or anionic functional groups of membranes for removing fine particles.

FIG. 2 is a system diagram showing a test device used in Examples.

### DESCRIPTION OF EMBODIMENTS

Hereinafter, embodiments of the present invention will be described in detail.

<Mechanism>

The mechanism with which a high fine particle removing capability can be attained using membranes modified with cationic or anionic functional groups in the present invention is considered as follows.

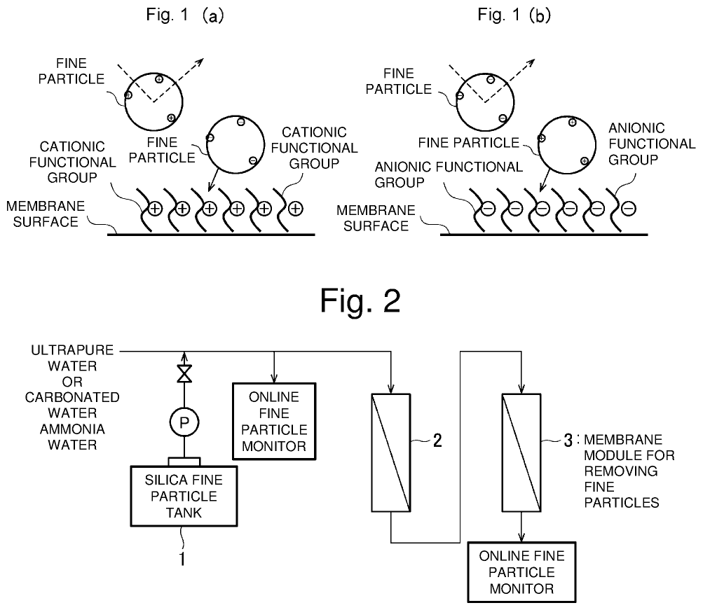

That is, minus-charged fine particles in a liquid are attracted toward plus charge of cationic functional groups introduced on a membrane as in FIG. 1(a), and captured and removed. Then, positively charged fine particles in a liquid are attracted toward negative charge of anionic functional groups introduced on a membrane as in FIG. 1(b), and captured and removed.

<Liquid to be Treated>

In the present invention, a liquid to be treated from which fine particles are to be removed is not especially limited, and examples thereof include pure water, alcohols such as isopropyl alcohol, inorganic acid aqueous solutions such as sulfuric acid aqueous solutions and hydrochloric acid aqueous solutions, alkali aqueous solutions such as ammonia aqueous solutions, thinners, carbonated water, hydrogen peroxide solutions and hydrogen fluoride solutions.

The present invention is effective for removing extrafine particles having a particle size of 50 nm or smaller, especially of 10 nm or smaller in these liquids.

Here, the concentration of the fine particles in the liquid to be treated is not especially limited, but is usually 100 μg/L or lower, or 0.03 to 10¹⁰ particles/mL. The pH of the liquid to be treated is not especially limited. However, the region where the ζ potential of fine particles is not inverted during liquid passing (region of not straddling the isoelectric point) is more preferred; and it is preferred that, for example, for positively charged alumina particles, the pH is always in the range of 8 or lower or always in the range of 8 or higher; and for negatively charged silica particles, the pH is always in the range of 3 or lower or always in the range of 3 or higher.

<Membrane Material and Membrane Form>

A material of a filtration membrane to become a base material of the membrane for removing fine particles according to the present invention is not especially limited, and may be a polymer membrane, may be an inorganic membrane, or may be a metal membrane.

As the polymer membrane, there can be used materials including polyolefins such as polyethylene and polypropylene, polyethers such as polyethylene oxide and polypropylene oxide, fluororesins such as PTFE, CTFE, PFA and polyvinylidene fluoride (PVDF), halogenated polyolefins such as polyvinyl chloride, polyamide such as nylon 6 and nylon 66, and urea resins, phenol resins, melamine resins, polystyrene, cellulose, cellulose acetate, cellulose nitrate, polyetherketone, polyetherketoneketone, polyetheretherketone, polysulfone, polyethersulfone, polyimide, polyetherimide, polyamideimide, polybenzimidazole, polycarbonate, polyethylene terephthalate, polybutylene terephthalate, polyp henylene sulfide, polyacrylnitrile, polyethernitrile, polyvinyl alcohol, and copolymers of these; but, usable materials are not limited to these materials. The material to be used is not especially limited to one kind of the materials and as required, various kinds thereof can be selected. A chargeable or conductive polymer may be mixed with another polymer such as a polyolefin or a polyether.

The inorganic membrane includes metal oxide membranes such as alumina and zirconia.

The form of the membranes is not especially limited, and suitable ones, such as hollow fiber membranes and flat membranes, may be used according to applications. For example, as a downstream end membrane module for removing fine particles of a unit of an ultrapure water device, a hollow fiber membrane is usually used. On the other hand, as a filter installed in a process cleaning machine, a pleated flat membrane is often used.

In the membrane for removing fine particles according to the present invention, since the membrane captures and removes fine particles in water by the electric adsorption capability by cationic or anionic functional groups introduced to the membrane, the pore size may be larger than the fine particles being an object to be removed, but when being excessively large, the efficiency of removing fine particles is poor; and when being excessively small, the pressure during membrane filtration becomes high, which is not preferred. Therefore, when the membrane is an MF membrane, one having a pore size of about 0.05 to 0.2 μm is preferred; and when being an UF membrane, one having a molecular weight cut-off of about 4,000 to 1,000,000 is preferred.

<Method of Introducing Functional Groups>

A method of introducing functional groups is not especially limited, and various methods can be adopted. For example, in the case of polystyrene, a sulfonic acid group can be introduced by adding an appropriate amount of paraformaldehyde in a sulfuric acid solution and carrying out heat crosslinking. In the case of polyvinyl alcohol, a functional group can be introduced, for example, by causing a trialkoxysilane group, a trichlorosilane group, an epoxy group or the like to act on the hydroxyl group. When a functional group cannot be introduced directly for some materials, the target functional group may be introduced through introducing operation in two or more stages, such as introducing a highly reactive monomer (called a reactive monomer) such as styrene and then introducing the functional group. The reactive monomer includes glycidyl methacrylate, styrene, chloromethylstyrene, acrolein, vinylpyridine and acrylonitrile, but is not limited thereto.

<Cationic Functional Group and a Method of Introducing the Cationic Functional Group>

A method of introducing a cationic functional group on a membrane is not especially limited, but includes a method using a chemical reaction, a method by coating and combined methods thereof. The method using chemical modification (chemical reaction) includes dehydrating condensation reaction. The method also includes plasma treatment and corona treatment. The method by coating includes methods of causing the membrane to be impregnated with an aqueous solution containing a polymer, or the like.

With regard to the method of introducing a cationic functional group by using chemical modification, for example, a chemically modifying method of imparting a weak cationic amino group to a polyketone membrane includes chemical reaction with a primary amine. Polyfunctionalized amines, including diamines, triamines, tetraamines and polyethyleneimines containing primary amines, such as ethylenediamine, 1,3-propanediamine, 1,4-butanediamine, 1,2-cyclohexanediamine, N-methylethylenediamine, N-methylprop anediamine, N,N-dimethylethylenediamine, N,N-dimethylprop anediamine, N-acetylethylenediamine, isophoronediamine and N,N-dimethylamino-1,3-propanediamine are preferred because many active points can be imparted.

When at least one hydrogen atom constituting a base material membrane is replaced by another group in the viewpoint of imparting a positive ζ potential, examples of a replacing method include a method in which radicals are caused to be generated by irradiation of electron beams, γ rays, plasma or the like; thereafter, a monomer having a reactive side chain such as glycidyl methacrylate is polymerized by graft polymerization; and a reactive monomer having a cationic functional group is added thereto. Examples of the reactive monomer include derivatives of acrylic acid, methacrylic acid or vinylsulfonic acid containing a primary amine, a secondary amine, a tertiary amine or a quaternary ammonium salt, allylamine and p-vinylbenzyltrimethylammonium chloride. More specific examples thereof include 3-(dimethylamino)propyl acrylate, 3-(dimethylamino)propyl methacrylate, N-[3-(dimethylamino)propyl]acrylamide, N-[3-(dimethylamino)propyl]methacrylamide, (3-acrylamidopropyl)trimethylammonium chloride and trimethyl[3-(methacryloylamino)propyl]ammonium chloride. The above addition process may be carried out before forming into a porous membrane, or may be carried out thereafter, but from the viewpoint of formability, it is preferred to carry out the addition process after forming into a porous membrane.

The polymer for imparting a positive ζ potential includes PSQ (polystyrene quarternary ammonium salts), polyethyleneimine, polydiallyldimethylammonium chloride, amino group-containing cationic poly(meth)acrylate esters, amino group-containing cationic poly(meth)acrylamides, polyamineamide-epichlorohydrin, polyallylamine, polydicyandiamide, chitosan, cationized chitosan, amino group-containing cationized starch, amino group-containing cationized cellulose, amino group-containing cationized polyvinyl alcohol, and acids salts of the above polymers. Then, the above polymers and the acids salts of the polymers may also be copolymers with other polymers.

<Anionic Functional Group and a Method of Introducing the Anionic Functional Group>

From the viewpoint of imparting a negative ζ potential, the anionic functional group includes one or more functional groups selected from the group consisting of a sulfonic acid group, sulfonate ester groups, a carboxylic acid group, carboxylate ester groups, a phosphoric acid group, phosphate ester groups and a hydroxyl group.

Examples of forms having functional groups include chemically bonded states and physically bonded states. The chemical bonds may be bonds like covalent bonds. The covalent bonds include C—C bonds, C═N bonds and bonds through a pyrrole ring. Chemically bonding substances may be polymers or may also be substances like monomers having a low molecular weight. On the other hand, the physically bonded state includes states being adsorbed, adhered or otherwise of bonding not through chemical bonds but through the hydrogen bond, the van der Waals force, the electrostatic force of attraction, or the intermolecular force such as the hydrophobic interaction.

The polymer for imparting a negative ζ potential includes polystyrenesulfonic acid, sodium polystyrenesulfonate, polyvinylsulfonic acid, sodium polyvinylsulfonate, poly(meth)acrylic acid, sodium poly(meth)acrylate, anionic polyacrylamide, poly(2-acrylamido-2-methylpropanesulfonic acid), poly(sodium 2-acrylamido-2-methylpropanesulfonate), carboxymethylcellulose, anionized polyvinyl alcohol and polyvinylphosphonic acid.

From the viewpoint of imparting a negative ζ potential, a porous membrane may be adhered or coated with a polymer having a negative ζ potential. The polymer having a negative ζ potential includes polystyrenesulfonic acid, sodium polystyrenesulfonate, polyvinylsulfonic acid, sodium polyvinylsulfonate, poly(meth)acrylic acid, sodium poly(meth)acrylate, anionic polyacrylamide, poly(2-acrylamido-2-methylpropanesulfonic acid), poly(sodium 2-acrylamido-2-methylpropanesulfonate), carboxymethylcellulose, anionized polyvinyl alcohol and polyvinylphosphonic acid. Then, the above polymers and the acids salts of the polymers may also be copolymers with other polymers.

When at least one hydrogen atom of polymers constituting the porous membrane is replaced by another group in the viewpoint of imparting a negative ζ potential to a porous membrane, examples of a replacing method include a method in which radicals are caused to be generated by irradiation of electron beams, γ rays, plasma or the like; thereafter, a reactive monomer having a functional group to develop the desired function is added thereto. Examples of the reactive monomer include derivatives of acrylic acid, methacrylic acid or vinylsulfonic acid containing a sulfonic acid group, a sulfonate ester group, a carboxylic acid group, a carboxylate ester group, a phosphoric acid group, a phosphate ester group or a hydroxyl group. More specific examples thereof include acrylic acid, methacrylic acid, vinylsulfonic acid, styrenesulfonic acid, and sodium salts of these, and 2-acrylamido-2-methylpropanesulfonic acid, 2-methacrylamide-2-methylpropanesulfonic acid, 2-acrylamido-2-methylpropanecarboxylic acid and 2-methacrylamido-2-methylpropanecarboxylic acid.

<Water Passing Order of an Anion Membrane and a Cation Membrane>

Both the membranes may be arranged in series, and the water passing order may be either of the anion membrane the cation membrane and the cation membrane the anion membrane. Separate containers having corresponding charged membranes may also be used.

When water is passed in the order of the anion membrane the cation membrane, the number of fine particles in a treated water becomes small.

When water is passed in the order of the cation membrane the anion membrane, the TOC concentration of a treated water becomes low. This is because positively charged functional groups are eliminated from the cation membrane, but the functional groups are captured, adsorbed and removed by charge by the negatively charged anion membrane.

In the present invention, it is allowed to install a region of an anion membrane and a region of a cation membrane in one container. When the corresponding membranes are packed in separate containers and arranged in series, it is preferred that the distance between the containers is as short as possible. When an anion membrane and a cation membrane are arranged in series, it is allowed to install an anionically charged region and a cationically charged region in each membrane or one membrane.

<Suitable Application Fields>

The apparatus for removing fine particles according to the present invention having the membranes for removing fine particles according to the present invention is suitably used in an ultrapure water production and feed system as an apparatus for removing fine particles in a sub-system to produce ultrapure water from a primary pure water system, particularly as an apparatus for removing fine particles in the last stage of the sub-system. The apparatus may also be installed on a feed-water line to feed the ultrapure water from the sub-system to a use point. The apparatus can further be used as a final apparatus for removing fine particles at the use point.

### EXAMPLES

Hereinafter, the present invention will be described more specifically by way of Examples.

In the following Examples 1 to 4 and Comparative Examples 1 to 6, test membranes used were as follows.

Cation membrane: Asahi Kasei Medical Co., Ltd., Qyu speed D (thickness: 70 μm)

Anion membrane: Pall Corp., ABD1UPWE3EH1 (thickness: 150 μm)

Then, test waters used were as follows.

Silica fine particle test water: an ultrapure water or a carbonated water at pH 4.8 containing silica fine particles (manufactured by Sigma-Aldrich Corp.) having a particle size of 22 nm added in a concentration of 1×10⁵ particles/mL

Alumina fine particle test water: an ultrapure water or a carbonated water at pH 4.8 containing alumina fine particles (manufactured by Sigma-Aldrich Corp.) having a particle size of 22 nm added in a concentration of 1×10⁵ particles/mL

[Evaluation of the Removal Rate of the Silica or Alumina Fine Particles]

By using the test device shown in FIG. 2, fine particles were injected from a silica or alumina fine particle tank 1 to an ultrapure water or a carbonated water at pH 4.8 to thereby prepare a fine particle test water, and the water was passed through membrane modules 2, 3 each installed with a test membrane under the condition of 10 m/d.

An inlet of the membrane module 2 and an outlet of the membrane module 3 were each provided with an online fine particle monitor UD120 (manufactured by Particle Measuring Systems Co.), and the fine particle removal rate was calculated from the numbers of fine particles in an inlet water and an outlet water.

### Example 1

The silica-containing water (ultrapure water or carbonated water) was passed through the anion membrane the cation membrane in order.

### Example 2

The alumina-containing water (ultrapure water or carbonated water) was passed through the anion membrane the cation membrane in order.

### Example 3

The silica-containing water (ultrapure water or carbonated water) was passed through the cation membrane the anion membrane in order.

### Example 4

The alumina-containing water (ultrapure water or carbonated water) was passed through the cation membrane the anion membrane in order.

### Comparative Example 1

The silica-containing water (ultrapure water or carbonated water) was passed only through the cation membrane.

### Comparative Example 2

The alumina-containing water (ultrapure water or carbonated water) was passed only through the cation membrane.

### Comparative Example 3

The silica-containing water (ultrapure water or carbonated water) was passed only through the anion membrane.

### Comparative Example 4

The alumina-containing water (ultrapure water or carbonated water) was passed only through the anion membrane.

### Comparative Example 5

As in Comparative Example 3, the water was passed, except for using the anion membrane of 300 μm in thickness.

### Comparative Example 6

As in Comparative Example 4, the water was passed, except for using the anion membrane of 300 μm in thickness.

The results of Examples 1 to 4 and Comparative Examples 1 to 6 are shown in Table 1.

TABLE 1

| | | | | Concentration | | |
|---|---|---|---|---|---|---|
| | | | | in feed- | Concentration | Removal |
| | Order of | Fine | Water | water | at outlet | rate |
| | passing water | particle | quality | (particles/mL) | (particles/mL) | (%) |
| Example 1 | Anion membrane → | Silica | Ultrapure | 1 × 10⁵ | <1 | <99.999 |
| | cation membrane | | water | | | |
| | | | Carbonated | 1 × 10⁵ | <1 | <99.999 |
| | | | water | | | |
| Example 2 | Anion membrane → | Alumina | Ultrapure | 1 × 10⁵ | <1 | <99.999 |
| | cation membrane | | water | | | |
| | | | Carbonated | 1 × 10⁵ | <1 | <99.999 |
| | | | water | | | |
| Example 3 | Cation membrane → | Silica | Ultrapure | 1 × 10⁵ | <1 | <99.999 |
| | anion membrane | | water | | | |
| | | | Carbonated | 1 × 10⁵ | <1 | <99.999 |
| | | | water | | | |
| Example 4 | Cation membrane → | Alumina | Ultrapure | 1 × 10⁵ | <1 | <99.999 |
| | anion membrane | | water | | | |
| | | | Carbonated | 1 × 10⁵ | <1 | <99.999 |
| | | | water | | | |
| Comparative | Cation membrane | Silica | Ultrapure | 1 × 10⁵ | 2 × 10¹ | 99.9 |
| Example 1 | only | | water | | | |
| | | | Carbonated | 1 × 10⁵ | 2 × 10¹ | 99.9 |
| | | | water | | | |
| Comparative | Cation membrane | Alumina | Ultrapure | 1 × 10⁵ | 6 × 10² | 99 |
| Example 2 | only | | water | | | |
| | | | Carbonated | 1 × 10⁵ | 8 × 10² | 99 |
| | | | water | | | |
| Comparative | Anion membrane | Silica | Ultrapure | 1 × 10⁵ | 2 × 10² | 99 |
| Example 3 | only | | water | | | |
| | | | Carbonated | 1 × 10⁵ | 4 × 10² | 99 |
| | | | water | | | |
| Comparative | Anion membrane | Alumina | Ultrapure | 1 × 10⁵ | 8 | 99.99 |
| Example 4 | only | | water | | | |
| | | | Carbonated | 1 × 10⁵ | 7 | 99.99 |
| | | | water | | | |
| Comparative | Anion membrane | Silica | Ultrapure | 1 × 10⁵ | 2 × 10¹ | 99.9 |
| Example 5 | (thickness: 300 μm) | | water | | | |
| | only | | Carbonated | 1 × 10⁵ | 3 × 10¹ | 99.9 |
| | | | water | | | |
| Comparative | Anion membrane | Alumina | Ultrapure | 1 × 10⁵ | 4 | 99.99 |
| Example 6 | (thickness: 300 μm) | | water | | | |
| | only | | Carbonated | 1 × 10⁵ | 5 | 99.99 |
| | | | water | | | |

### Experimental Example 1

As a blank test, a water was passed under the same condition as in Example 1, except for using, as the passing water, an ultrapure water, a carbonated water at pH 4.8 or an ammonia water at pH 11 containing no silica nor alumina fine particles added.

### Experimental Example 2

As a blank test, a water was passed under the same condition as in Example 3, except for using, as the passing water, an ultrapure water, a carbonated water at pH 4.8 or an ammonia water at pH 11 containing no silica nor alumina fine particles added.

The results of Experimental Examples 1 and 2 are shown in Table 2. Then, in Experimental Examples 1 and 2, the TOCs of treated waters (waters having passed through both the membranes) when the ultrapure water was passed were measured. The results are shown in Table 2.

TABLE 2

| | | | | | | TOC of |
|---|---|---|---|---|---|---|
| | | | | Concentration | Concentration | treated |
| | | Fine | Water | in feed-water | at outlet | water |
| | Order of passing water | particle | quality | (particles/mL) | (particles/mL) | (μg/L) |
| Experimental | Anion membrane → | None | Ammonia | <1 | <1 | — |
| Example 1 | cation membrane | | water | | | |
| | | | Ultrapure | <1 | <1 | 2 |
| | | | water | | | |
| | | | Carbonated | <1 | <1 | — |
| | | | water | | | |
| Experimental | Cation membrane → | None | Ammonia | <1 | 5 | — |
| Example 2 | anion membrane | | water | | | |
| | | | Ultrapure | <1 | 5 | <0.5 |
| | | | water | | | |
| | | | Carbonated | <1 | 4 | — |
| | | | water | | | |

### CONSIDERATION

(1) As seen in Table 1, the series disposition of the anion membrane and the cation membrane exhibited the performance of removing 99.999% or more of the 22-nm silica, whose ζ potential was negative in the ultrapure water and the weak acidic region. Further, the series disposition exhibited the performance of removing 99.999% or more of the 22-nm alumina particles, whose ζ potential was positive in both the regions. The removing performance was excellent to the performance of the Comparative Examples, which used the membrane singly.

(2) By disposing the anion membrane and the cation membrane in series in this order, the number of fine particles in the treated water was reduced. This is because since almost all dust particles from materials of the membranes (resin-based) and piping (Teflon-based) were negatively charged particles in liquids, the dust particles were adsorbed and removed by the cation membrane on the downstream end.

(3) As seen in Table 2, in Experimental Example 1, in which the ultrapure water was passed through the anion membrane the cation membrane in order, the TOC concentration of the treated water was 2 μg/L, whereas in Experimental Example 2, in which the ultrapure water was passed through the cation membrane the anion membrane in order, the TOC concentration was as low as lower than 0.5 μg/L. This is because positively charged functional groups were eliminated from the cation membrane, but were captured and adsorbed and removed by charge by the negatively charged anion membrane.

The present invention has been described in detail by using the specific aspect, but it is obvious to those skilled in the art that the present invention may be variously changed and modified without departing from the spirit and the scope of the present invention.

The present application is based on Japanese Patent No. 2019-066872, filed on Mar. 29, 2019, the entire contents of which are hereby incorporated by reference.

### REFERENCE SIGNS LIST

1 FINE PARTICLE TANK
2, 3 MEMBRANE MODULE

1. An apparatus for removing fine particles, comprising membranes for removing fine particles in a liquid, wherein a microfiltration membrane or ultrafiltration membrane having a positive charge and a microfiltration membrane or ultrafiltration membrane having a negative charge are arranged in series.

2. A method for removing fine particles, using an apparatus for removing fine particles according to claim 1.

3. The method for removing fine particles according to claim 2, wherein a liquid is passed through the membrane having a negative charge and the membrane having a positive charge in order.

4. The method for removing fine particles according to claim 2, wherein a liquid is passed through the membrane having a positive charge and a membrane having a negative charge in order.
